(19) United States
(12) Patent Application Publication
(10) Pub. No.: US 2012/0179425 A1
(43) Pub. Date: Jul. 12, 2012

(54) METHOD AND APPARATUS FOR RETRIEVING A PHASE OF A WAVEFIELD

(75) Inventor: Fucai Zhang, Sheffield (GB)

(73) Assignee: UNIVERSITY OF SHEFFIELD, Sheffield (GB)

(21) Appl. No.: 13/496,361

(22) PCT Filed: Sep. 10, 2010
(86) PCT No.: PCT/GB2010/051516

§ 371 Date: Mar. 15, 2012

(30) Foreign Application Priority Data
Sep. 15, 2009 (GB) 0916167.0
Oct. 13, 2009 (GB) 0917930.0

(51) Int. Cl. G06F 15/00

(52) U.S. Cl. 702/189

(57) ABSTRACT

A method of retrieving a phase of a wavefield comprising the steps of: providing an estimate of the wavefield φ0 at an initial plane; and propagating the wavefield to and fro between an entrance plane being a plane having an area to which the wavefield is confined and a detector plane via a wavefield transform device, wherein at the entrance plane a support constraint is applied and at the detector plane a magnitude constraint is applied, the wavefield transform device being arranged to apply a wavefield transform function to the wavefield, wherein the wavefield transform function is characterised by a finite deviation from a lens function.

### FIELD OF THE INVENTION

The present invention relates to a method and corresponding apparatus for retrieving a phase of a wavefield. In some embodiments a method is provided for constructing an image of an object based on intensity measurements of a diffraction pattern formed by radiation scattered from the object.

### BACKGROUND

It is recognised that images of an object may be constructed from measurements of the phase and intensity of a wavefield scattered by the object. However, image detectors are typically incapable of measuring phase of the wavefield, providing instead a measurement of intensity only. The so-called ‘phase problem’, i.e. the problem of determining the phase of the wavefield has been the subject of much interest.

Solutions to the phase problem typically involve iterative calculations of wavefield based on measurements of intensity of the diffraction pattern.

Sayre proposed the possibility of recovering the phase of a wavefield diffracted from a finite object from its diffraction intensity alone (D. Sayre, Acta Crystallographica 5, 843 (1952)). Algorithms utilizing finite support as an object constraint were put forward by Fienup (J. R. Fienup, Optics Letters 3, 27 (1978)) in 1978. The solution uniqueness and convergence dependency on boundary shape, symmetry and sharpness of these algorithms were extensively investigated by Fienup and other researchers, see for example R. Barakat and G. Newsam, Journal of Mathematical Physics 25, 3190 (1984), R. H. T. Bates, Optics (Jena) 61, 247 (1982) and J. R. Fienup and C. C. Wackerman, Journal of the Optical Society of America A 3, 1897 (1986).

Given a tight support and a particular object wavefield distribution, reconstructions have been shown possible using simulated data. Despite these theoretical advancements however, few experimental results of convincing quality were demonstrated until the x-ray reconstruction of gold pattern by Miao and coworkers in 1999 (J. Miao, P. Charalambous, J. Kirz, and D. Sayre, Nature (London) 400, 342 (1999)).

Subsequent experiments have applied this technique to samples including a simple gold particle (J. Miao, T. Ishikawa, B. Johnson, E. H. Anderson, B. Lai, and K. O. Hodgson, Phys. Rev. Lett. 89, 088303 (2002)), a complex yeast cell (D. Shapiro, et al., Proc. Natl. Sci. U.S.A. 102, 15343 (2005)) and tomographic mapping of strain fields inside a nano-crystal (M. A. Pfeifer, G. J. Williams, I. A. Vartanyants, R. Harder, and I. K. Robinson, Nature 442, 63 (2006)).

Meanwhile algorithms mostly based on the Hybrid Input-Output (HIO) algorithm, were also improved by various ways. The tight support requirement may be avoided by the shrink-wrap algorithm that is able to refine the estimate of support together with the object in the course of iteration (S. Marchesini, et al., Phys. Rev. B 68, 140101 (2003)).

Phase retrieval from a single diffraction pattern demonstrated so far is still limited to small, isolated specimens. This presents a fundamental limitation for its wide use in material and biological science.

A finite exit wave as required in this technique can also be provided by illuminating an extended object with a finite probe. Phase retrieval in this case however faces many difficulties due to the smoothed boundary and the loss of non-negativity (J. R. Fienup, J. Opt. Soc. Am. A 4, 118 (1987), J. M. Rodenburg and H. M. L. Faulkner, Appl. Opt. 85, 4795 (2004)).

In general, these algorithms are inherently accompanied with the translation and Hermite symmetry ambiguities as discussed by J. R. Fienup and C. C. Wackerman, J. Opt. Soc. Am. A 3, 1897 (1986). Competition of these ‘trivial’ solutions could cause slow convergence. In certain situations, it has been recently shown that reconstruction of extended object is possible if the illumination is curved and also known precisely (B. Abbey, et al., Nat. Phys. 4, 394 (2008)).

Another obstacle in current Coherent Diffraction Imaging techniques (CDIs) is a very stringent requirement placed on a detector's dynamic range and noise performance. To cover the full range of a typical diffraction pattern, a detector of dynamic range of order 2²⁰ is required. This is well beyond the capability of the commonly used detectors such as the charge coupled device (CCD). A beamstop must be used to block the central beam, but this gives rise to the so-called missing data problem which has to be kept low or amended using data measured by other means.

Another fundamental obstacle in current CD is the difficulty in collecting the high-angle diffraction data. In the case of x-ray or electron radiation, most real samples of interest are weakly diffracting. Thus only a very small fraction of the incident beam energy will be diffracted into high angle zones; diffraction into high angle (or high order) zones in order to obtain higher resolution images. Even with a perfect detector without noise, it still requires a relatively long time period for a detector to obtain a sufficient number of counts. Some samples cannot withstand irradiation for the length of time required.

By using a brighter and costly radiation source is able to reduce the data acquisition time by some mounts, but it will cause even increased sample damage

FIG. 1(a) shows a known experimental arrangement in which a beam of radiation (which may also be described as a wavefield) from a source 10 is scattered by an object 20 provided in an object plane. The scattered wavefield 30 is then incident on a detector 40 arranged to measure intensity of the wavefield.

FIG. 1(b) illustrates a known method of iteratively calculating phase and amplitude of the wavefield 30. A support constraint is applied to an estimate of the wavefield in the object plane which is then propagated to the detector plane where a magnitude constraint is applied (the magnitude of the wave at the detector plane being determined from the measurement of wavefield intensity by the detector 40).

U.S. Pat. No. 6,369,932, U.S. Pat. No. 6,545,790 and U.S. Pat. No. 6,906,839 disclose a system and method for recovering phase information of a wave front. The documents disclose irradiating a specimen of material with collimated radiation and passing the radiation through a stop having a predetermined blocking pattern or one or more filters. The intensity distribution of radiation passed through the stop or filter(s) is recorded. This procedure is repeated at least five times with a different respective stop or filter being used each time.

### STATEMENT OF THE INVENTION

In a first aspect of the invention there is provided a method of retrieving a phase of a wavefield comprising the steps of: providing an estimate of the wavefield φ₀ at an initial plane; and propagating the wavefield from the initial plane and to and fro between an entrance plane being a plane having an area to which the wavefield is confined and a detector plane, wherein at the entrance plane a support constraint is applied and at the detector plane a magnitude constraint is applied, and wherein a wavefield transform device is provided in a path of the wavefield between the entrance plane and the detector plane, the wavefield transform device being arranged to apply a wavefield transform function to the wavefield, the wavefield transform function being characterised by a finite deviation from a lens function.

By ‘finite’ is included a large or small deviation from a lens function. In other words the wavefield transform function is not a perfect lens function. Nor is the wavefield transform function simply a free space propagator. Preferably the deviation from a lens function is large. Preferably the deviation from a lens function is large enough to enable retrieval of phase of the wavefield within a prescribed number of iterations of the method.

By lens function is meant a function of a device that can convert a wavefield emanating from one point into another wavefield that appears as emanating from or converging to a different point. In particular, a lens function is a function that can convert a spherical wave (or its low order approximation) into another spherical wave (or its low order approximation). Reference to the term ‘point’ here should also be understood to cover a ‘spot’ in the diffraction limited sense.

For the avoidance of doubt, by lens function is not included a free space propagator.

Advantageously the wavefield transform function deviates significantly from a lens function.

It is to be understand that by the phrase ‘to and fro’ is meant that the wavefield is propagated between the entrance plane and the detector beginning in either the first direction or the second direction depending upon the choice of a programmer implementing the algorithm or the user of the method.

Furthermore it is to be understood that the initial plane may be at or between the entrance plane and the detector plane. Alternatively the initial plane may be upstream from the entrance plane.

The entrance plane is a plane in which it is known that the flux of the wavefield is confined to an area.

It is to be understood that embodiments of the invention have the advantage that a phase of a wavefield may be retrieved from a single dataset corresponding to intensity of a wavefield. In other words in some embodiments of the invention it is not necessary to obtain multiple datasets corresponding to different respective recordings of intensity of a wavefield made by a detector. This ‘one-shot’ feature has the advantage that it enables phase retrieval to be performed of dynamic events where intensity in an image is changing in real time. For example, phase retrieval of images obtained from in-situ experiments may be performed, and in cases where a sample is found to deteriorate as a function of time under irradiation by the wavefield.

The present invention has the advantage over U.S. Pat. No. 6,369,932, U.S. Pat. No. 6,545,790 and U.S. Pat. No. 6,906,839 that phase retrieval may be performed using only a single dataset corresponding to a distribution of a wavefield intensity. The present invention is further distinguished from U.S. Pat. No. 6,369,932, U.S. Pat. No. 6,545,790 and U.S. Pat. No. 6,906,839 since the present invention requires the application of a support constraint.

Previously, application of a support constrain required a small isolated sample. This limitation is overcome by embodiments of the present invention wherein a wavefield transform device typically having a strong modulation property is employed. When a wavefield is back propagated from the wavefield transform device to the entrance plane in which the support constraint is applied, incorrect components of the wavefield estimate are propagated outside of the support so that the support constraint is of increased effectiveness in refining the estimate of the wavefield.

Preferably the wavefield transform function is applied to the wavefield as the wavefield passes between the entrance plane and the detector plane in a first direction and an inverse of the wavefield transform function is applied to the wavefield as it passes between the entrance plane and the detector plane in a second direction opposite the first direction.

The method may comprise iteratively calculating phase of the wavefield by repeatedly propagating the wavefield to and fro between the entrance plane and the detector plane. In some embodiments the wavefield transform device is arranged such that the optical path lengths of rays passing through the device are such that the intensity resulting from their coherent addition is sufficiently different from that of a perfect lens to enable phase retrieval to be performed to a required spatial resolution within a prescribed number of iterations.

The wavefield transform function may be characterized by application of a Fourier transform to the wavefield, subsequently multiplying the wavefield by a modulation function, subsequently applying a further Fourier transform to the wavefield, the modulation function being a function having a finite deviation from a lens function

By the expression ‘characterized by’ is meant that the wavefield transform function may be directly in the form of the recited steps or equivalent to without requiring the recited steps to be explicitly performed.

Embodiments of the invention have the advantage that high-angle signal intensities can be obtained that are several orders of magnitude higher than those obtainable by means of current CDI techniques without requiring a stronger radiation source and without increasing sample damage.

As discussed above, for x-ray or electron radiation most samples are weakly scattering and therefore relatively low number of photons or electrons are scattered to high angles. It is desirable for a larger number of photons or electrons to be scattered into high-angle zones.

Prior art solutions involve the use bright radiation sources such as free electron lasers which can generate up to 10³³ photons/pulse. Free electron lasers can cost tens or hundreds of million dollars to build. However much of the energy will be lost in the form of the direct beam, resulting in increased sample damage.

Embodiments of the invention have the advantage that phase may be retrieved for a wavefield with soft-edges and large phase variations or of extended objects illuminated with a finite probe.

Embodiments of the invention have the further advantage that phase may be retrieved from a single recording of intensity, for example a single recording of intensity of a diffraction pattern. Furthermore, the method allows phase retrieval from diffraction data recorded without a requirement for a detector having large dynamic range.

Rather, a detector having a dynamic range of order 2¹⁰-2¹⁴ is typically sufficient.

A key aspect of the method is the employment of a wavefield transform device (WTD) having a known transmission or reflection function (or ‘transfer function’). The WTD can be a device of known multiplicative modulation function (in general a complex modulation function), or a system of known impulse response function (transfer function in Fourier domain). A plurality of WTDs may be employed, to form a wavefield transform system.

Embodiments of the invention are suitable for use with wavefields having radiation of a range of wavelengths and type, such as visible light, infra-red light, ultraviolet light, radiation of terahertz frequencies, x-ray radiation, electron radiation, neutron radiation and any other suitable radiation. Acoustic wavefields may also be employed in some embodiments.

The support constraint S is preferably applied according to the equation:

φₙ₊₁=φ′ₙS+β(φ′ₙ−φₙ)(1−S), (3)

where φₙ and φ′ₙ are a current and an updated estimate of an entrance wavefield of an n^{th} iteration respectively, φ′ₙ being set equal to φₙ at a first iteration.

Preferably wherein S takes a value of unity at pixels where the wavefield to be measured is assumed to have significant value, and zero otherwise.

The magnitude constraint may be applied to determine an estimate of the wavefield at the detector plane φₙ₊₁^{D} according to the equation φₙ₊₁^{D}=Aₙ₊₁ exp(iφₙ₊₁) where Aₙ₊₁ and φₙ₊₁ denote amplitude and phase, respectively, of the wavefield at the detector.

The magnitude constraint is preferably applied according to the equation φ′ₙ₊₁^{D}=P(I)exp(iφₙ₊₁), where φ′ₙ₊₁^{D} is the wavefield at the detector after applying the magnitude constraint, I is the recorded diffraction intensity and P(I) is a function of intensity I.

Preferably P(I) takes the form P(I)=I^{γ} where γ is a constant.

The method preferably comprises the step of setting γ to a value substantially in the range of from around 0.5 to 2.

The method may comprise the steps of performing n₁ iterations with a first value of γ, subsequently performing n₂ iterations with a second value of γ.

The first value of γ may be greater than the second value.

The second value of γ may be 0.5.

The method may comprise the step of selecting β to have a value in the range of from around 0.4 to around 0.8.

The method may comprise the step of selecting β to have a value of 0.62.

The method may comprise the step of selecting values of γ, β and S to enable a signal to error ratio SER to have a value of less than or substantially equal to 10⁻⁵ after around 100 iterations.

The method may be preceded by the step of providing an initial estimate of the wavefield at an initial plane.

The initial plane may be provided at a location which is one selected from amongst coincident with the entrance plane, coincident with the detector plane and between the entrance plane and the detector plane.

The wavefield transform device may be arranged to exhibit one selected from amongst a linear response and a nonlinear response to an incident wavefield.

The wavefield transform device may be arranged to have a complex transmission being a transmission exhibiting both loss and phase retardance.

The wavefield transform device may comprise at least one selected from amongst a phase plate, a one dimensional grating, a two dimensional grating, a slab of crystal and a spatial light modulator.

The wavefield transform device may comprise a plurality of cross-coupled optical fibres arranged to convey light incident from an inlet plane of the wavefield transform device to an exit plane of the wavefield transform device.

By cross-coupled is meant that light from one fibre can couple to one or more other fibres.

The device may be arranged to convey light between respective positions of the inlet and exit planes of the device such that the wavefield transform function is characterised by a finite deviation from a lens function by virtue of at least one selected from amongst a correspondence between respective positions of ends of respective fibres at the inlet and exit planes of the device and a length of respective fibres.

Thus, in some embodiments the fibres are all of substantially the same length but arranged to ‘scramble’ the phase and amplitude by effectively swapping the positions of pixels of the wavefield at the inlet plane of the WTD as the wavefield is conveyed from the inlet plane to the exit plane. Optionally, the fibres may additionally be of different lengths thereby to introduce a phase shift to a wavefield conveyed by a given fibre.

Further alternatively, the fibres may be of different lengths but the positions of pixels between the inlet and exit planes may be substantially unchanged.

The wavefield transform device may be arranged to be one selected from amongst transmissive of incident radiation and reflective of incident radiation.

The wavefield transform device may comprise a plurality of pixel elements.

The method may comprise the step of adjusting an orientation of the wavefield transform device with respect to the detector and/or the entrance plane.

The method may further comprise the step of providing a plurality of waveform transform devices.

The method may comprise the step of providing a plurality of waveform transform devices in a cascade configuration whereby a wavefield is arranged to pass between the entrance and detector planes via each of the plurality of devices.

The wavefield transform function may be one selected from amongst discrete and continuous.

The method may comprise the step of providing a waveform transform device comprising at least one selected from amongst an aberrated lens and a complex lens system having non-negligible aberration.

The waveform transform function may be one selected from amongst a reversible operator and a non-multiplicative operator.

Data recorded by the detector may be arranged to correspond to one selected from amongst a Fraunhofer diffraction pattern, a Fresnel diffraction pattern and an aberrated image.

The support constraint may be one selected from amongst a length of a 1D region, a boundary of a 2D area and a 3D volume.

The support constraint may be applied to a plurality of spatially separated regions.

The wavefield may comprise a plurality of spatially separated regions.

The wavefield may comprise one selected from amongst a 3D wavefield, a 2D wavefield and a 1D signal.

The wavefield transform device may be arranged to scatter at least one selected from amongst electromagnetic radiation, optical photons, x-ray photons, electrons, neutrons and protons.

Preferably the wavefield comprises electromagnetic radiation selected from amongst terahertz frequency radiation, infrared radiation, visible light radiation, deep-ultraviolet radiation, soft X-ray radiation and hard X-ray radiation.

The wavefield may be arranged to comprise substantially coherent radiation.

The wavefield may be arranged to consist substantially of coherent radiation.

The wavefield may be a wavefield scattered by an object.

The method may comprise the step of calculating phase of the wavefield in one or more planes of the object.

The method may comprise calculating phase and amplitude of the wavefield at a required location of a path of the wavefield.

In a second aspect of the invention there is provided a method of retrieving a phase of a wavefield comprising the steps of: providing a wavefield transform device arranged to apply a wavefield transform function to a wavefield, wherein the wavefield transform function is characterized by a function having a finite deviation from a lens function; passing a wavefield from an entrance plane to a detector plane via the wavefield transform device and recording an intensity of the wavefield at the detector plane by means of a detector, the method further comprising the steps of: propagating the wavefield in a virtual manner to and fro between the entrance plane and the detector plane via the wavefield transform device, wherein at the entrance plane a support constraint is applied and at the detector plane a magnitude constraint is applied, the magnitude constraint corresponding to the intensity recorded by the detector.

The wavefield incident on the wavefield transform device may be a wavefield that has been scattered by an object.

The step of propagating the wavefield in a virtual manner to and fro between the entrance plane and the detector plane may be preceded by the step of providing an estimate of the wavefield φ₀ at an initial plane.

In a third aspect of the invention there is provided apparatus for retrieving a phase of a wavefield comprising: a wavefield transform device arranged to apply a wavefield transform function to a wavefield, wherein the wavefield transform function is characterized by a function having a finite deviation from a lens function; a detector responsive to intensity of the wavefield; and a computer system, the apparatus being arranged to allow a wavefield to propagate from the entrance plane, being a plane in which the wavefield is confined to a finite area, via the wavefield transform device to the detector, the computer system being arranged to propagate a virtual wavefield to and fro between the entrance plane and the detector, the computer system being arranged to apply a support constraint to the wavefield at the entrance plane and a magnitude constraint to the wavefield at the detector, the system being arranged to apply the wavefield transform function to the wavefield as the wavefield is propagated between the entrance plane and the detector, thereby to retrieve the phase of the wavefield at a required position of the wavefield.

The computer system may be arranged iteratively to calculate phase of the wavefield by repeatedly propagating the wavefield to and fro between the entrance plane and the detector plane.

The computer system may be arranged to apply the wavefield transform function to the wavefield as the wavefield passes between the entrance plane and the detector in a first direction and an inverse of the wavefield transform function as the wavefield passes between the entrance plane and the detector in a second direction opposite the first direction.

The wavefield transform function may be characterised by a finite deviation from a lens function.

The step of propagating a virtual wavefield to and fro between the entrance plane and the detector is preferably preceded by the step of propagating the wavefield from an initial plane.

The computer system may be arranged to provide an estimate of the wavefield at the initial plane and subsequently to propagate the wavefield from the initial plane and between the entrance plane and the detector.

Alternatively or in addition the computer system may be arranged to prompt a user to input an estimate of the wavefield at the initial plane and subsequently to propagate the wavefield from the initial plane and between the entrance plane and the detector.

It is to be understood that an initial estimate of the wavefield may be an initial estimate of the wavefield at substantially any location between the source of the wavefield and the detector. The algorithm is then commenced at a stage corresponding to the position at which the initial estimate of the wavefield is made.

Thus, if the initial estimate is an estimate at a location between the incident plane and the plane of the WTD the algorithm may be arranged to propagate the wavefield to the plane of the WTD and then to apply the wavefield transform function before continuing according to the flow chart of FIG. 4. Alternatively the algorithm may be arranged to propagate the wavefield to the incident plane and to apply the support constraint before continuing according to the flow chart of FIG. 4.

### BRIEF DESCRIPTION OF THE DRAWINGS

Embodiments of the invention will now be described with reference to the accompanying figures in which:

FIG. 1 shows (a) a prior art arrangement of components for measurement of scattered wavefield intensity and (b) a prior art method of determining amplitude and phase of the scattered wavefield;

FIG. 2 shows arrangements of components of apparatus according to embodiments of the invention in a transmission geometry;

FIG. 3 shows an arrangement of components of apparatus according to an embodiment of the invention in a reflection geometry in which the entrance plane, modulator plane and detector plane are (a) parallel and (b) non-parallel;

FIG. 4 shows steps of an algorithm for determining amplitude and phase of a wavefield according to an embodiment of the invention;

FIG. 5 shows an arrangement of apparatus according to an embodiment of the invention;

FIG. 6 is a schematic illustration of a design of wavefield transform devices according to embodiments of the invention showing (a) a plan view and (b) an enlarged perspective view of a portion of a surface of one device; FIG. 6(c) shows a perspective view of a device incorporating a plurality of optical fibres whilst FIG. 6(d) and FIG. 6(e) show an inlet plane and exit plane respectively as viewed along a direction from the inlet plane to the exit plane;

FIG. 7 shows images used to provide values of (a) amplitude and (b) phase of a wavefield used in one example to demonstrate phase retrieval using a method according to the present invention;

FIG. 8 shows a plot of signal to error ratio (SER) as a function of number of iterations for three values of support looseness Θ;

FIG. 9 shows data recorded during a process of reconstruction of a monocotyledon sample showing (a) a diffraction pattern recorded by a detector with an enlarged view inset; (b) an amplitude map at the plane in which the support constraint is applied (the constraint applied plane’) during a process of iteratively calculating amplitude and phase at this plane; and (c) an amplitude map and (d) a phase map at the sample plane;

FIG. 10 shows (a) a plan view of a wavefield transform device having a 2D periodic phase structure as viewed along a direction parallel to a direction of propagation of a wavefield towards the wavefield transform device and (b) a plot of signal to error ratio SER as a function of iteration number during a process of determining amplitude and phase of the wavefield according to an embodiment of the invention using this wavefield transform device;

FIG. 11 shows (a) a plan view of a wavefront modulator having a 1D periodic phase structure as viewed along a direction parallel to a direction of propagation of a wavefield towards the wavefield transform device and (b) a plot of signal to error ratio SER as a function of iteration number during a process of determining amplitude and phase of the wavefield according to an embodiment of the invention using this wavefield transform device; and

FIG. 12 shows (a) a map of phase of an amplitude transfer function of an imaging system used as a wavefield transform device; (b) a plot of SER as a function of iteration number during a process of determining amplitude and phase of the wavefield according to an embodiment of the invention using this wavefield transform device; (c) a reconstructed map of wavefield amplitude at the object plane and (d) a reconstructed map of wavefield phase at the object plane.

FIG. 13 shows (a) the amplitude and (b) the phase of a 1D test signal used to demonstrate the operation of embodiments of the invention.

FIG. 14 shows (a) the amplitude and (b) the phase of the signal of FIG.13 after a single iteration of an algorithm for determining amplitude and phase of a wavefield according to an embodiment of the invention.

FIG. 15 shows (a) the amplitude and (b) the phase of the signal of FIG. 13 after a a plurality of iterations of an algorithm for determining amplitude and phase of a wavefield according to an embodiment of the invention.

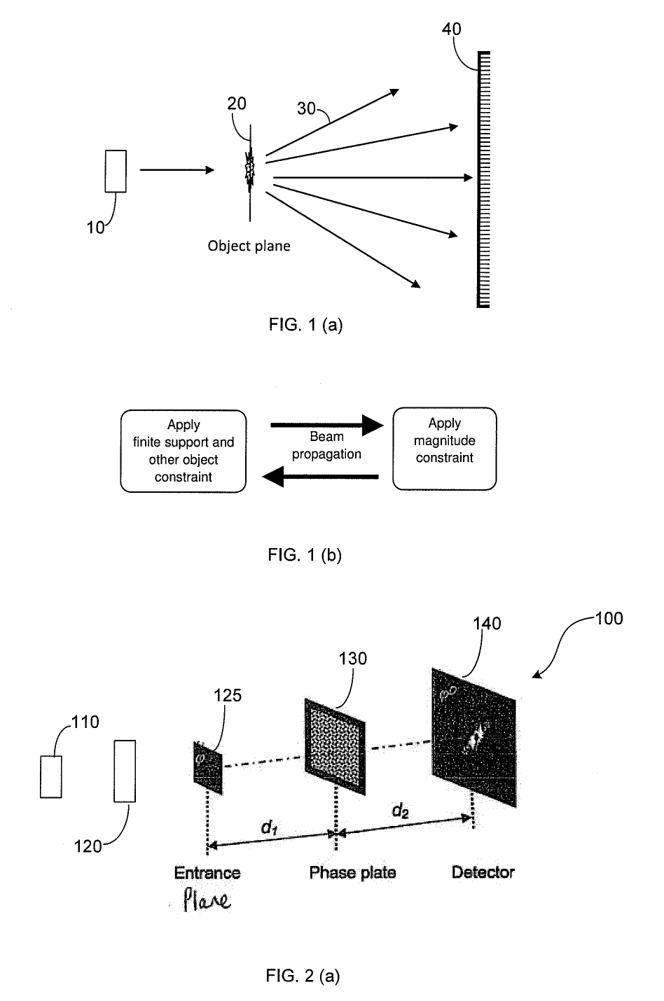

### DETAILED DESCRIPTION

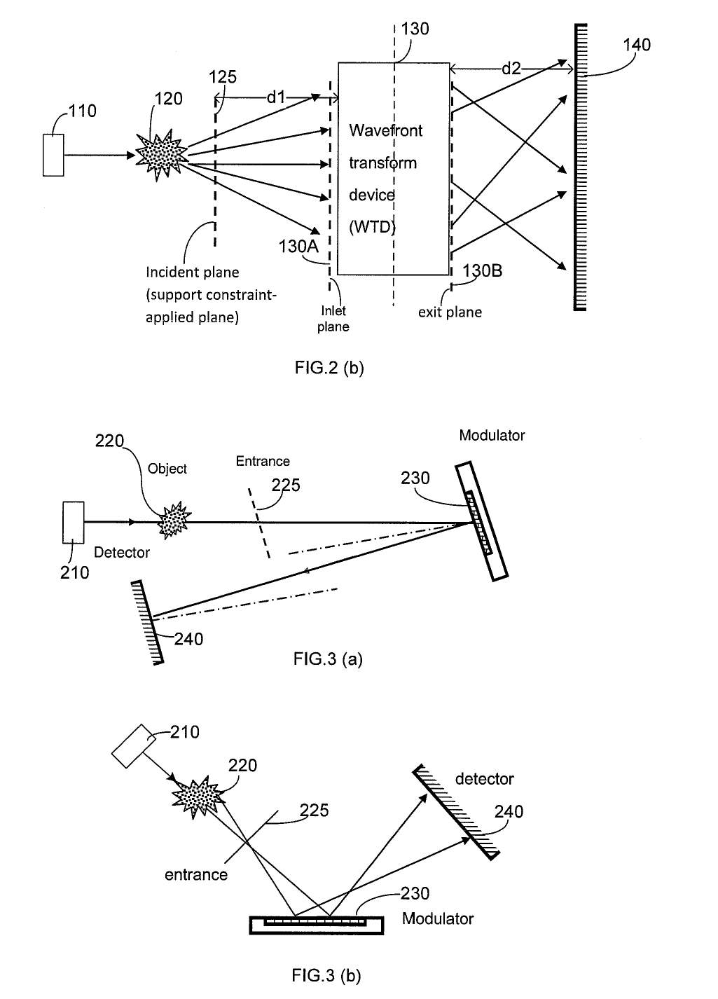

In one embodiment of the invention apparatus 100 is provided having components arranged as shown in FIG. 2(a). The apparatus 100 has an illumination source 110 arranged to illuminate an object 120 with radiation. Radiation scattered by the object 120 is arranged to be incident upon and to be transmitted through a wavefield transform device (WTD) 130, which may also be referred to as a wavefront modulation device. In the case of the example of FIG. 2(a) the WTD 130 is in the form of a phase plate.

Radiation scattered by the WTD 130 is arranged to be incident upon a detector 140. The radiation will be described herein as a wavefield characterised at any given location in space by a value of amplitude and a value of phase.

The configuration of FIGS. 2(a) and (b) may be referred to as a transmission mode of operation since radiation is transmitted through the WTD 130 and is incident upon the detector 140 positioned on the opposite side of the WTD 130.

An incident plane 125 is also shown in FIGS. 2(a) and (b). The incident plane 125 is a plane in which a support constraint is applied. In some embodiments the incident plane 125 may be referred to as an entrance plane 125.

The incident plane 125 may be upstream or downstream from the object 120. In some embodiments the incident plane 125 is arranged to be at or near a cross-over of a beam of radiation from the illumination source 110 thereby to limit an area of the illumination at the incident plane.

In some alternative embodiments the incident plane is chosen to coincide with a plane of the object 120. Other locations of the incident plane 125 are also useful.

Other WTDs are also useful including spatial light modulators (SLMs).

FIG. 2(b) shows an arrangement similar to that of FIG. 2(a) in which the WTD 130 is shown having an inlet plane 130A and an exit plane 130B mutually spaced apart from one another.

FIGS. 3(a) and (b) show apparatus arranged in a reflection mode of operation. In the particular arrangement of FIG. 3(a) the incident plane 225, WTD plane 230 and detector plane 240 are each substantially parallel to one another. In the arrangement of FIG. 3(b) the incident plane 225, WTD plane 230 and detector plane are not all mutually parallel to one another.

It is to be understood that in the arrangements of FIG. 3(a) and (b) radiation from the source 210 is scattered by an object 220 towards a WTD 230 and on to a detector 240 arranged to detect light ‘reflected’ by the WTD 230.

The WTD 230 may be a strongly modulated phase analyzer of known structure and may be inserted in a conventional CDI setup at a location downstream from the sample. In this case the arrangement of the apparatus may be similar in some respects to that disclosed by Zhang et al (see above reference) in the multi-image reconstruction algorithm.

The effect of using a WTD is twofold. First, the interdependency of the samples of intensity made by the detector is strengthened since portions of the wavefield scattered by a greater number of points of the illuminated object are incident on the detector where interference of the portions takes place.

The strengthened interdependency provides the overdetermination mechanism to the phase inverse problem. This is in contrast to the disclosure of Zhang et al. where the overdetermination is mostly provided by uncorrelated multiple recordings.

Second, the diffraction pattern is spread out into a wider volume of reciprocal space than the original object, providing a more even intensity distribution of reduced dynamic range. This in turn has the advantage that the dynamic range required of the detector is reduced compared with prior art methods.

In describing the arrangement of FIG. 2(a) the positions of at least three planes are specified. These are the plane in which the WTD 130 is located, the plane in which the detector 140 is located and an “incident plane” 125.

In the arrangement of FIGS. 2(a) and (b) the incident plane 125, a plane of the WTD 130 and a plane of the detector 140 are substantially parallel and spaced apart along a direction of propagation of the wavefield by distances d₁ and d₂ respectively. In some alternative embodiments the incident plane 125, the plane of the WTD 130 and the plane of detector 140 are not mutual parallel.

In some embodiments the location of the WTD is specified in terms of an inlet plane 130A of the WTD and an exit plane 130B of the WTD, see e.g. FIG. 2(b).

A requirement of methods according to the present invention is that at the incident plane 125 the extent of the wavefield is finite, although a boundary of the wavefield need not exhibit an abrupt change in intensity, i.e. the boundary can be soft.

To effect wave propagation between planes, the Fresnel algorithm may be adopted. The Fresnel approximation condition can be easily fulfilled by appropriate selection of values of d₁ and d₂ (FIG. 2).

If the apparatus is configured for far field conditions, as in the case of x-ray and electron wave diffraction, a Fourier transform may be used as the beam propagator.

In the Fresnel algorithm, the sampling intervals at different planes are related. By way of example, if the detector has N×N pixels, each of which are square and of side Δx_{D}, the sampling intervals at the WTD Δx_{M} and incident plane Δx are given by:

Δx_{M}=λd₂/NΔx_{D} (1)

Δx=λd₁/NΔx_{M}=(d₁/d₂)Δx_{D} (2)

where λ is the wavelength of the radiation employed.

If the incident plane 125 is defined as coincident with the object 120, Δx is also the achievable spatial resolution of images of the object 120 reconstructed using amplitude information obtained from the detector 140 and phase information determined according to the present method.

In deriving equations 1 and 2 above, no assumption is made in respect of how rapidly the wavefield at the three planes varies. In the case of a smooth wavefield, a coarse sampling interval may be sufficient and other known beam propagation algorithms such as the angular spectrum method may be advantageous to use. For example, they may allow for a larger field of view.

In some embodiments the transmission area of the WTD 130 is limited in order that the resultant diffracted wave can be sufficiently sampled by the detector 140. In the embodiment of FIG. 2 a side length of the WTD 130 is set to be of length NΔx, a value just large enough to fulfil the Nyquist sampling requirement for the wavefield in the plane of the detector 140.

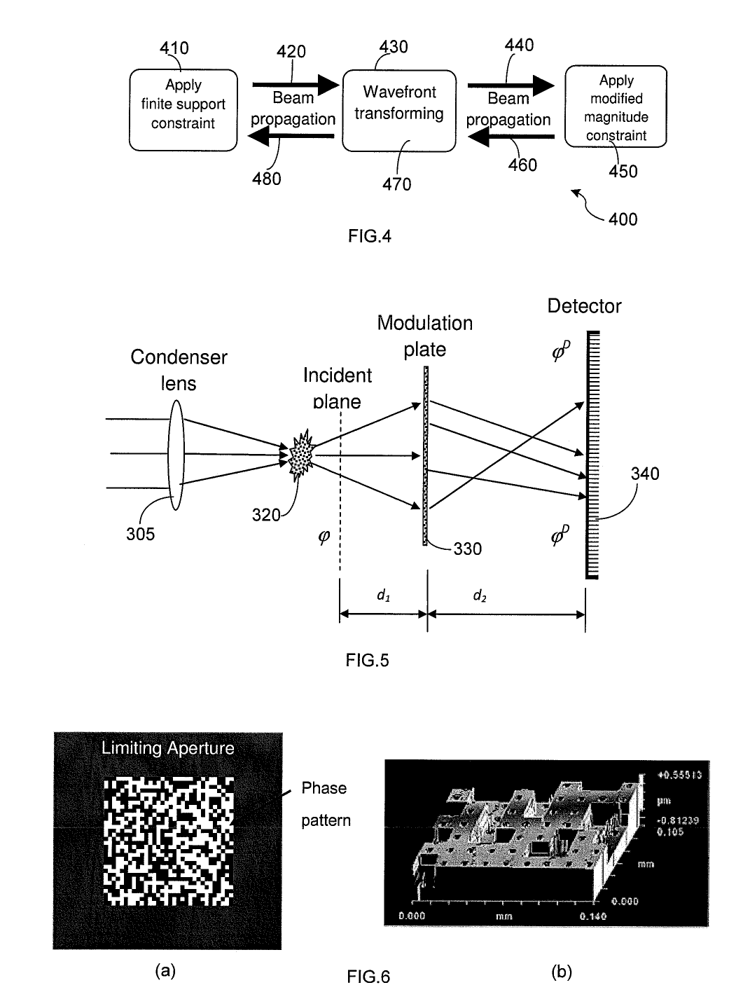

The phase recovery method is in the form of an algorithm 400 illustrated schematically in FIG. 4. In some embodiments the method begins with an estimate of the entrance wavefield being the wavefield at the entrance plane. The entrance wavefield may be written φ₀(pΔx,qΔx) where p and q are the discrete spatial coordinates.

The method proceeds as follows. Firstly, the support constraint is applied 410 to obtain a further estimate of the wavefield:

φₙ₊₁=φ′ₙS+β(φ′ₙ−φₙ)(1−S), (3)

where φₙ and φ′ₙ are the current and updated estimates, respectively, of the incident wavefield in the n^{th} iteration. In the interests of clarity and conciseness the spatial coordinates have been omitted. This formula may also be referred to as an ‘update formula’.

φ′ₙ is set equal to φₙ at the first iteration. S denotes the support constraint and takes a value of unity for pixels where the wavefield to be measured is assumed to have a significant value, and zero otherwise. The parameter β can be adjusted to alter the feedback strength and takes a value in the range of around 0.4 to around 0.8. A value β=0.62 has been used for both the simulated and experimental reconstructions presented here unless otherwise specified.

Secondly, the wavefield is propagated 420 to the plane of the WTD 130.

Subsequently, the wavefield is multiplied 430 by the complex transmission of the WTD in order to determine the expected form of the wavefront after encountering the WTD.

The wavefield is then propagated 440 to the plane of the detector 140, yielding φₙ₊₁^{D}=Aₙ₊₁ exp(iφₙ₊₁); where Aₙ₊₁ and φₙ₊₁ denote amplitude and phase respectively.

The intensity of radiation measured by the detector 140 (being the square of the magnitude) is known, and accordingly the next step according to the method is to apply 450 a magnitude constraint:

φ′ₙ₊₁^{D}=I^{γ} exp(iφₙ₊₁), (4)

where I is the recorded diffraction intensity. The parameter γ can be adjusted in the range of from around 0.5 to around 2. It is found that the convergence is strongly dependent on the value of γ; a large value leads to a big change in the solution from iteration to iteration and is able to determine the contour of the wavefield quickly, though with relatively poor quality.

In some embodiments the first n₁ iterations are performed with a large value of γ, and a final n₂ iterations are performed with a smaller value of γ, such as γ=0.5. The total number of iterations is thus n₁+n₂.

The wavefield is then back-propagated 460 to the WTD and the effect of the WTD is removed by dividing 470 the wavefield at the WTD by the transmission function of the WTD.

Subsequently, the wavefield is back propagated 480 to the entrance plane, yielding an updated estimate of the entrance field φ′ₙ₊₁.

The above method steps are repeated in an iterative manner until an improvement between sequential estimates becomes sufficiently small or until a given number of iterations have been performed.

As discussed above, it is to be understood that an initial estimate of the wavefield may be an initial estimate of the wavefield at substantially any location between the source of the wavefield and the detector. The algorithm is then commenced at a stage corresponding to the position at which the initial estimate of the wavefield is made.

Thus, if the initial estimate is an estimate at a location between the incident/entrance plane and the plane of the WTD the algorithm may be arranged to propagate the wavefield to the plane of the WTD and then to apply the wavefield transform function before continuing according to the flow chart of FIG. 4. Alternatively the algorithm may be arranged to propagate the wavefield to the incident plane and to apply the support constraint before continuing according to the flow chart of FIG. 4.

The update formula, equation (3) above, is different from that used in the HIO algorithm. The formula is selected to be compliant with the introduction of the parameter γ in equation (4) above.

In step 5, 450, the parameter γ may be changed stepwise. In some embodiments it is found that a better overall rate of convergence may be obtained by gradually reducing γ to the value 0.5 as iteration proceeds. In some embodiments the parameter γ is not changed. In some embodiments the parameter γ is not changed at every iteration; rather, the parameter γ is changed at prescribed times, e.g after a predetermined number of iterations, such as alternate iterations.

Other forms of magnitude constraint are also useful.

The method 400 described above was implemented in a computing device by means of an algorithm and run with artificially constructed datasets representing the intensity and phase of a wavefield.

The algorithm was tested with various wavefields including a wavefield having a relatively hard boundary, a wavefield having a relatively soft boundary, a wavefield having a substantially flat phase variation and a wavefield having a large variation in phase over the range [−π, π] across the wavefield.

FIG. 5 shows an example of an arrangement in which a condenser lens 305 is used to focus a wavefield from a source onto a sample 320. Radiation scattered by the sample 320 passes through a WTD 330 in the form of a thin plate and is subsequently incident on a detector 340 sensitive to intensity of the wavefield.

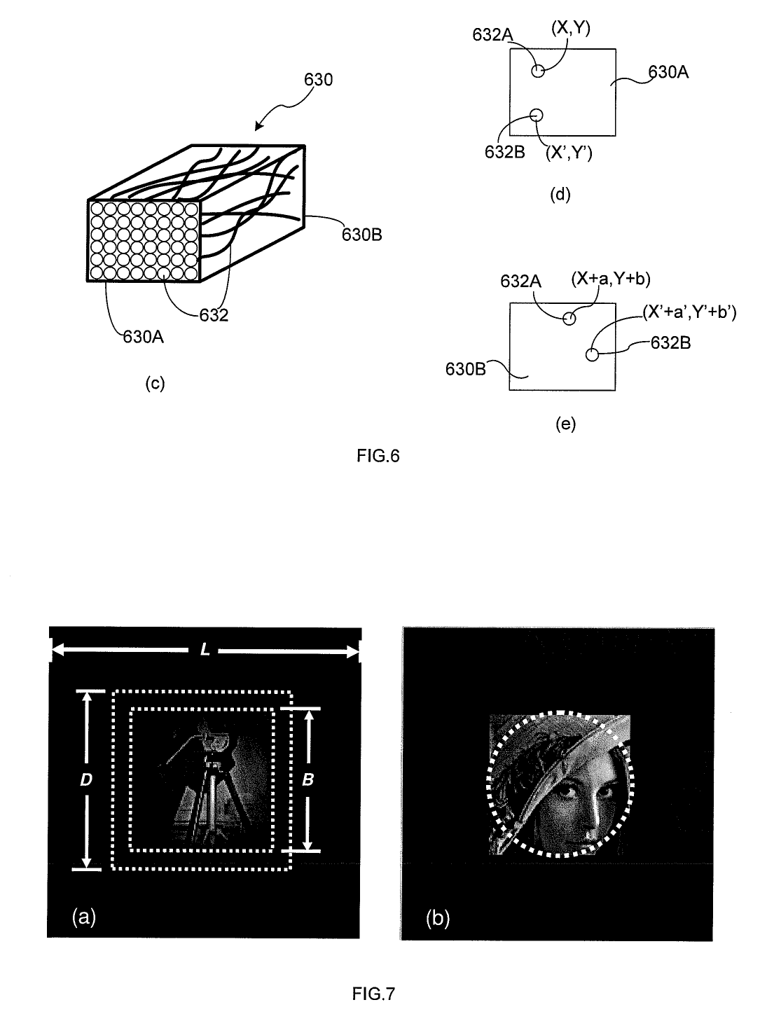

FIG. 6 shows an example of a WTD according to an embodiment of the invention. The dark pixellated pattern of FIG. 6(a) shows portions of the WTD that are arranged to reduce an amplitude of the wavefield transmitted by those portions. Alternatively, the dark pixellated pattern of FIG. 6(a) shows portions of the WTD that are arranged to retard a phase of the wavefield transmitted by those portions. FIG. 6(b) shows a perspective view of a portion of a surface of the phase plate showing discrete variations in thickness of the phase plate, step changes in the thickness variations being at boundaries between adjacent pixels.

FIG. 6(c) shows an example of a further WTD 630 according to an embodiment of the invention. The WTD 630 has an inlet plane 630A and an exit plane 630B mutually spaced apart and having a plurality of optical fibres 632 running therebetween. A wavefield incident on the inlet plane 630A is conveyed by the fibres 632 to the exit plane 630B. The fibres 632 are arranged such that the wavefield emerging from the exit plane is subject to a transform function that maps at least one optical fibre 632 at prescribed coordinates (X, Y) of the inlet plane 630A to different prescribed coordinates (X+a, Y+b) of the exit plane 630B when both planes 630A, 630B are viewed along the same direction, e.g. along a direction from the inlet plane 630A to the exit plane 630B.

Thus the wavefield appearing at the outlet plane 630B is effectively a ‘scrambled’ version of the wavefield at the inlet plane 630A.

FIG. 6(d) is a schematic illustration of the inlet plane 630A of the WTD 630. A first free end of each of a first and a second fibre 632A, 632B is shown, at positions (X, Y) and (X′, Y′) respectively.

FIG. 6(e) is a schematic illustration of the exit plane 630B of the WTD 630 as viewed looking in a direction from the inlet plane 630A to the exit plane 630B. A second free end of the first fibre 632A is shown at position (X+a, Y+b) where a and b are non-zero and a second free end of the second fibre 632B is shown at position (X′+a′, Y′+b′) where a′ and b′ are nonzero.

Thus, a wavefield incident on the inlet plane 630A appears at the exit plane 630B with a spatial rearrangement of intensity and phase as compared with that of a wavefield where no ‘scrambling’ is introduced, e.g. the case where a, b, a′ and b′ are all zero.

Other arrangements are also useful.

In some embodiments the computing device may be arranged to provide values of magnitude and phase at any prescribed plane from the entrance plane to the detector or upstream of the entrance plane. For example the computing device may be arranged to provide values of amplitude and phase at any required position within the sample thereby to provide images of an internal volume of the sample or any other required image, such as a transmission image of the entire volume of the sample.

### EXAMPLE 1

Results are presented obtained from measurements of a wavefield having relatively soft edges and relatively strong phase variations.

Conventional CDI methods would have difficulty solving for this situation.

A wavefield was generated using the images presented in FIGS. 7(a) and (b). Intensity values of pixels of the image of FIG. 7(a) were multiplied with intensity values of corresponding pixels of an Airy disc to define the amplitude of the wavefield. Incorporation of the Airy disc provides a soft boundary to the image. The amplitude was scaled to the range [0, 1].

Corresponding values of the phase of the wavefield were defined using the image of FIG. 7(b) scaled to phases in the range [0, 2π]. The dotted circle superimposed on the image of FIG. 7(b) indicates the corresponding position of the contour of the first zeros of the Airy disc applied to FIG. 7(a).

The setup parameters used for the algorithm were: λ=635 nm; d₁=9.7 mm; d₂=47.7 mm and Δx_{D}=7.4 μm.

For this example, the WTD was selected to be a phase plate with a designed pattern having a substantially random spatial variation in phase retardance, each location of the plate having a phase retardance of either 0 or π.

A diffraction pattern was calculated, the pattern having a 256×256 samples quantized to 2¹² levels.

In practice, it may be difficult to locate the true boundary of the wave. In this case, a factor accounting for the degree of looseness of the support constraint may be introduced:

Θ=(D/B)² (5)

where B and D are the linear dimensions of the wavefield extent and the support, respectively, as depicted in FIG. 7(a).

In the present example the true entrance wave is known and therefore the convergence of the algorithm can be measured directly using the signal to error ratio

$$SER = \frac{\sum {\vert {ϕ}_{test} \vert}^{2}}{\sum {( \vert {ϕ}_{n} \vert - \vert {ϕ}_{test} \vert )}^{2}} \qquad ( 6 )$$

where the summation runs through all the sampling indices.

SER is the reciprocal of the mostly used normalised RMS error measure. However, the error measure in the diffraction plane is not suitable for use here because of the introduction of parameter γ in our algorithm. For the first n₁ iterations, the calculated RMS would be very large and meaningless; in contrast, SER would provide a small value. Measured values of SER as a function of the number of iterations are also able to provide information about the convergence behavior of the algorithm from the slope of a plot of SER as a function of number of iterations.

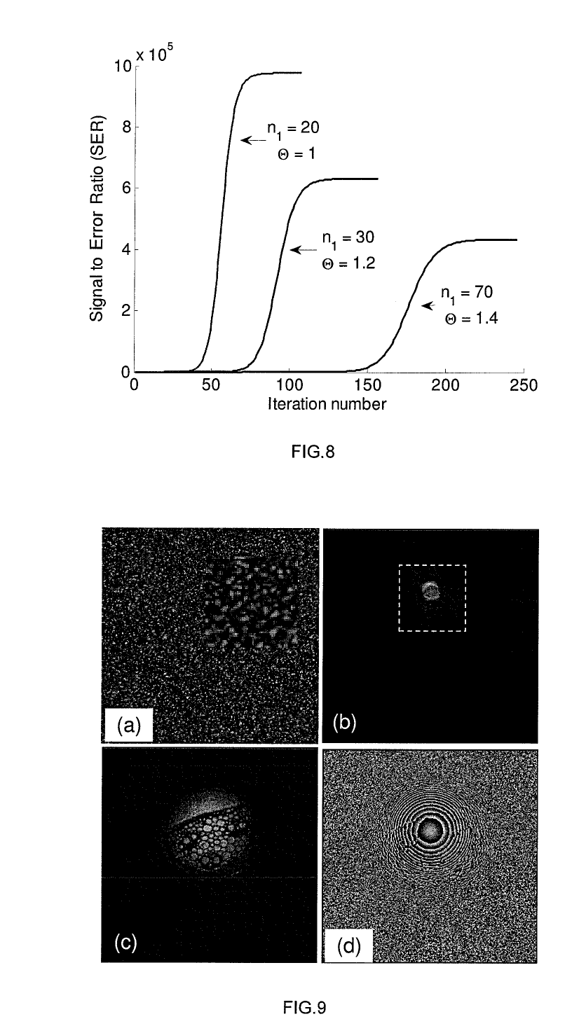

FIG. 8 shows plots of SER as a function of number of iterations for three values of Θ. It is to be understood from the plots that the algorithm described above converges rapidly even when there is a considerable amount of uncertainty in the provided support. In the case where Θ=1.4, B and D take values of 116 and 138, respectively.

For the present example, the support was 11 pixels broader than the real boundary around all sides. With the increase of looseness Θ, the final SER reduces and the convergence slope slows down. The iteration terminates when the relative change of sequential SER is less than 10⁻⁵.

Different values of n₁ were used in order to obtain the three curves. As a general rule, a large value of n₁ is preferred when Θ is large. The reconstructed amplitude once SER>100 was indistinguishable from the original by eye. Furthermore, the calculated value of phase differed from the original value by a constant offset, and therefore the reconstructed images are not shown here.

We have also performed simulations for a wavefield with symmetrical amplitude and phase distributions. Similar convergence performance was also obtained.

As the method does not require a well-defined boundary of the wavefield, the incident plane, where the support constraint would be applied, does not necessarily have to lie in the object plane.

In some embodiments it is found that use of a plane in which the wavefield has the smallest extent gives the fastest convergence and best image quality even if the support size used (in pixels) remains the same.

In some embodiments the fill factor defined as FF=(B/L)² at the entrance plane, where L is the linear dimension of field of view at the entrance plane, is found to be the most crucial parameter in determining the convergence.

In the above simulation, a WTD with a random phase pattern and pixel size Δx_{M} was used. In practice, it is desirable that the feature size of the WTD is large in order to facilitate easy manufacture of the WTD. If the coherence of the radiation source is not a limitation, the WTD pixel size can be freely selected by changing the distances d₁ and d₂. In some embodiments the feature size of the WTD can be selected to be much larger than Δx_{M}.

Experiments have been performed in which binning of pixels of the WTD was performed. For a test entrance wavefield, the amplitude and phase maps of FIG. 2 were re-sized to give a fill factor of 1/9. For a plate pixel size of 4× and 6× the value of Δx_{M}, the required number of iterations to obtain a SER value of 100 was 44 and 223 respectively.

For a weak phase object with a curved illumination, it is possible to use an even bigger pixel size in the WTD. Consider a possible x-ray experiment at 8 keV, with a desired resolution Δx=20 nm, d₂=8 m, N=256 and Δx_{D}=24 μm. The distance d₁ is calculated to be 3.3 mm and Δx_{M}=200 nm according to equations (1) and (2).

A WTD with a feature size of around 1 μm is easily achievable with current fabrication techniques and can be used in this configuration.

There is also a great flexibility in the design of the transmission profile of the WTD for better convergence of the algorithm or for better energy efficiency of the whole system.

Any fabrication error in the WTD can be accounted for in the algorithm if its accurate modulation function or transfer function can be obtained after fabrication.

The term ‘modulation function’ is understood to refer to a multiplicative wavefield transform function (transmission or reflection) whilst the term ‘transfer function’ is understood to refer to a convolution wavefield transform function such as is characteristic of a lens.

Reference herein to ‘transform function’ is to be understood to include reference to a modulation function or transfer function.

In some embodiments in which a WTD being a phase shifting plate is employed, the modulation function can be directly calculated from measurements of a surface profile of the WTD. Surface profile measurements may in some embodiments be made using a confocal microscope or surface profilers.

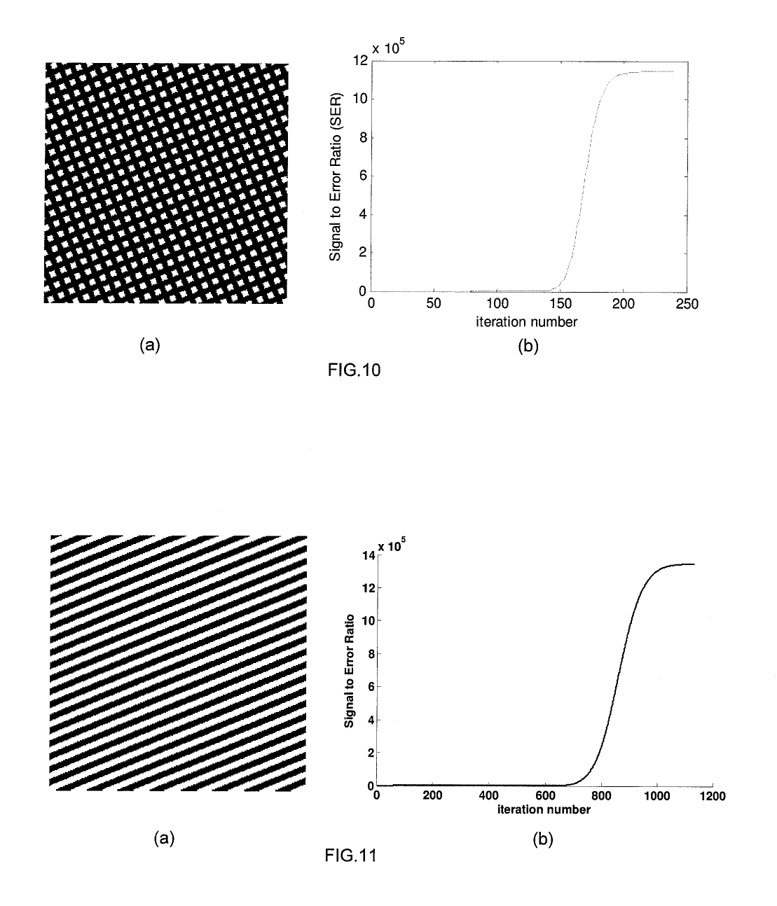

FIG. 10(a) is a schematic illustration of a WTD having a two-dimensional periodic phase structure. FIG. 10(b) shows a plot of signal to error ratio (SER) as a function of the number of iterations of an algorithm according to an embodiment of the invention using a WTD having such a two-dimensional periodic phase structure.

FIG. 11(a) is a schematic illustration of a WTD having a one-dimensional periodic phase structure. FIG. 11(b) shows a corresponding plot of signal to error ratio (SER) as a function of the number of iterations of an algorithm according to an embodiment of the invention using a WTD having such a one-dimensional periodic phase structure. It can be seen from FIG. 10(b) and FIG. 11(b) that a lower number of iterations are required with a WTD having a two-dimensional periodic phase structure compared with a WTD having a one-dimensional periodic phase structure.

The fact that one-dimensional or two-dimensional WTDs that have a periodic modulation function may be used is significant in applications where x-ray or electron radiation is employed since a slab of a crystalline material may be used as a WTD. Other slabs of material are also useful in some embodiments, including single crystalline and polycrystalline slabs of material.

A reflective WTD may also be used, as described by C. Kohler, F. Zhang, and W. Osten, Applied Optics 48, 4003 (2009). This may be particularly important for applications requiring the use of wavelengths for which reflective components are more readily available than refractive ones, such as relatively short wavelengths.

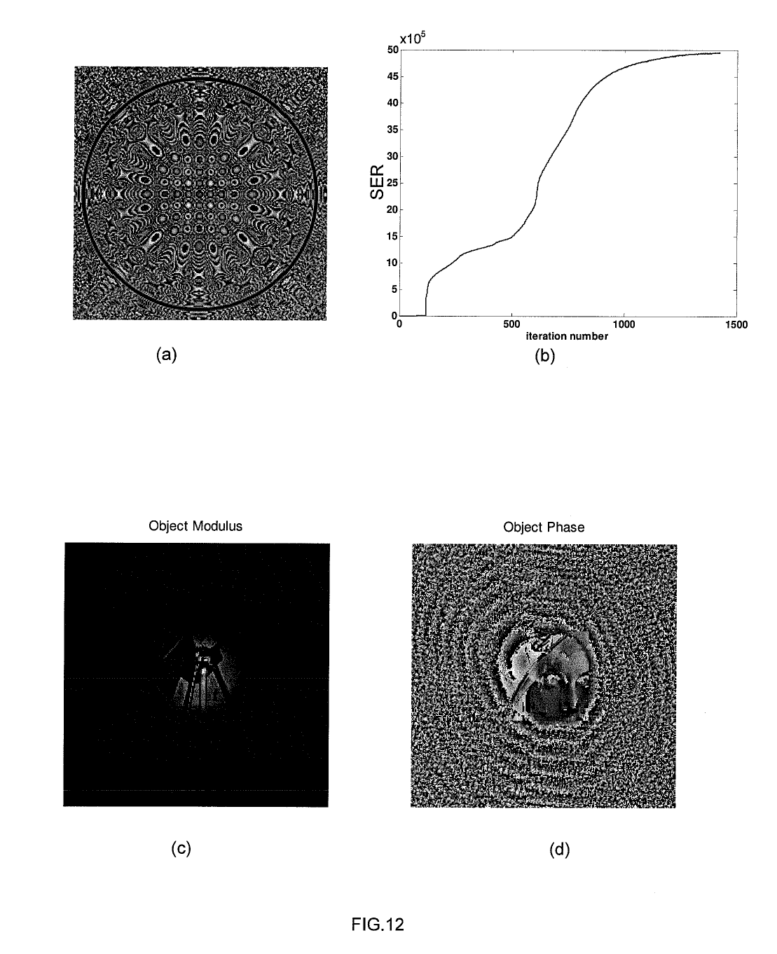

FIG. 12(a) is a map of the phase of an amplitude transfer function of an imaging system having an aberration and used as a WTD. FIG. 12(b) shows a corresponding plot of SER as a function of the number of iterations of an algorithm according to an embodiment of the invention using the WTD shown in FIG. 12(a). FIGS. 12(c) and 12(d) respectively show the reconstructed maps of (c) amplitude and (d) phase at the object plane.

### EXAMPLE 2

A beam of light from a 635 nm laser diode was collimated and converged by a lens with a focal length of 50 mm to provide an illumination probe as illustrated in FIG. 5. A WTD was placed a distance of around 18.45 mm behind a crossover of the beam. The WTD was formed from silica glass etched with varying thickness to deliver a required phase retardance.

The WTD was formed to have 1100×1100 pixels, each square in shape as per the embodiment shown in FIG. 6 and 16 μm across. Each pixel was provided with a pinhole, the array of pixels thereby providing a phase pattern. The pinholes had a hole size of 6 μm to minimize artifacts due to the transition edge between pixels.

It is to be understood that pinholes are not required and arrangements not including pinholes are also useful.

A CCD camera having square pixels each of side 7.4 μm was placed 70 mm downstream from the WTD to record the diffraction pattern.

A microscopic monocotyledon specimen was used as the test sample. The test sample was placed at a location 19.88 mm upstream from the WTD.

FIG. 9(a) shows the recorded diffraction pattern which shows a uniformly distributed fully developed speckle pattern due to the use of the WTD. A portion of the pattern has been enlarged and is shown inset.

As described above, WTDs according to embodiments of the invention are arranged to scatter an incident wavefield such that an intensity of an image of a central beam of the diffraction pattern is reduced due to scattering to a relatively high angle region of the diffraction pattern thereby dramatically enhancing the dark field signal.

This can be especially advantageous for radiation sensitive samples. For example exposure of certain samples to x-ray or electron radiation can give rise to substantial radiation damage. Thus, a requirement of prior art techniques to use a beam stop in order to record high angle diffraction data may be overcome by some embodiments of the present invention.

Embodiments of the present invention also allow detectors of reduced dynamic range to be employed. This is again a consequence of the enhancement of intensity of the dark field signal and reduction in intensity of the central beam.

In the present example, the central 376×376 samples of the diffraction pattern were used to reconstruct an image of the sample. The number 376 was calculated according to Eq. 1 to fulfil the required scale relationship.

FIG. 9(b) shows the reconstruction of amplitude in the incident plane in which the support constraint is applied after n₁=30; n₂=20 iterations. The incident plane was selected to be the cross-over plane of the probe. The boundary of the support used is indicated by a dotted line the FIG. 9(b).

It is to be understood from FIG. 9(b) that the support is actually relatively loose (having a relatively high ‘looseness’) since the area of the support constraint is much larger than the area over which the incident wavefield has significant signal intensity.

No support refinement algorithm was applied in the course of this iteration, such as the shrink-wrap algorithm. However, adoption of a support refinement algorithm may lead to even more rapid convergence of the algorithm.

FIG. 9(c) shows a map of amplitude of the wavefield at the plane of the sample and FIG. 9(d) shows a corresponding map of phase of the wavefield at this location.

### EXAMPLE 3

It is well known that phase retrieval for a one dimensional (1D) signal is much more difficult than higher dimensional cases (2D or 3D) since the phase problem itself becomes more likely to be underdetermined. Retrieving the phase of a one-dimensional signal has many applications, such as in the shape determination of ultra-short pluses and in geodetic surveying, among others. This example demonstrates that methods according to embodiments of the invention can also work equally well for 1D signal by numerical experiments.

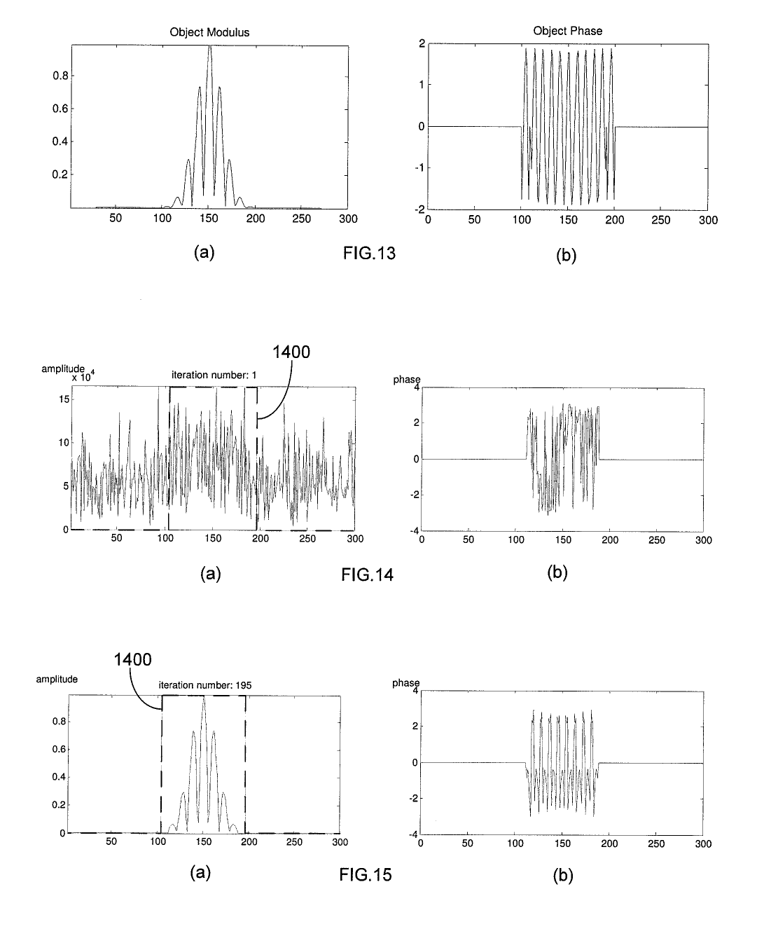

Different kinds of signals have been tested. Here, a signal with a strongly varying phase and soft edges as shown in FIGS. 13(a) and (b) was selected. For such kind of signal, the existing methods would face grave difficulties. The modulation function of modulator has a variation only in phase, which was uniformly distributed within the range of 0 and 2π. An intensity map was generated by the Fresnel beam propagation algorithm. The process of phase retrieval started with a guessed wave with the amplitude and the phase as shown in FIGS. 14(a) and (b). The amplitude was a modulated Gaussian pulse with rolling down edges; the phase was a truncated sinusoidal wave. The rectangle in FIG. 14(a) indicates a region 1400 of applied support constraint. FIG. 15 shows a reconstructed amplitude and phase after 120 iterations. As can be appreciated, the support constraint 1400 that was applied is in fact larger than the actual signal extent. The insensitivity to support tightness demonstrates a great advantage of this method over other Fienup algorithm based methods.

The signal shown in FIG. 13 was selected by way of example. Other signals, including one with a strong random phase—the most difficult situation one would encounter in practice, have also been tested. Similar convergence performance has been obtained.

Embodiments of the present invention provide a new method for the measurement of phase of a wavefield. This technique is suitable for complex-valued fields with either weak or strong phase variation. The technique overcomes the isolated sample requirement of current CDI methods using a single diffraction pattern measurement. It also greatly enhances the capability to collect high-angle diffraction data compared with current CDI methods. A loose support is sufficient to provide a rapid convergence. The method involves a relatively simple experimental arrangement and is not sensitive to external vibration and therefore is readily applicable to on-site applications, showing advantages over methods based on two-beam interference techniques such as interferometry and off-axis holography. Embodiments of the invention are suitable for real-time applications and investigation of phenomenon that occur on short time scales.

The method is compatible with a very promising solution to the sample damage problem using a pulsed laser, see for example H. N. Chapman, et al., Nat. Phys. 2, 839 (2006).

It is to be understood that the WTD may take one or more of a number of different forms.

For example, the WTD may be a plate and the wavefront transform function may be in the form of a multiplicative transmission/reflection function.

The WTD may also be a system. The wavefront transform function may be in the form of an impulse response function (or transfer function in the Fourier domain).

Other forms of WTD are also useful including devices having linear or nonlinear response.

In the case of a simple multiplicative device, the WTD may be a phase plate, for example a phase plate having a complex transmission (i.e. having both loss and phase retardance).

In some embodiments the WTD is a one dimensional or two dimensional grating. The WTD may for example be a slab of crystal arranged to scatter radiation such as x-ray radiation, electrons, neutrons, protons or any other suitable radiation.

The WTD may comprise a spatial light modulator. The WTD may be reflective and/or transmissive.

The WTD may be arranged in a tilted orientation with respect to the detector.

In some embodiments the WTD has a pixelated structure. The WTD may be arranged to be cascaded in combination with one or more further WTDs.

The modulation function associated with the WTD may be discrete. Alternatively the modulation function may be continuous

In case of a complex system (described by convolution) the WTD may comprise an aberrated lens and/or a complex lens system having a certain amount of aberration.

The WTD may be a reversible operator. The WTD may be non-multiplicative.

It is to be understood that data recorded by the detector may correspond to one selected from amongst a Fraunhofer diffraction pattern, a Fresnel diffraction pattern and an aberrated image

The modulus constraint may involve a general nonlinear function of the intensity.

Embodiments of the invention provide a solution to the general phase measurement problem of a wavefield over a broad range of applications. Apart from the potential to turn CDIs into a routine technique for use in material and biomedical sciences, the method also finds application in metrology and wavefield sensing in addition to other applications.

In one embodiment a wavefield transform device is provided in abutment with a detector. In some embodiments the object is provided in abutment with the wavefield transform device. In some embodiments the object, wavefield transform device and detector are each provided in abutment with one another. Thus, reference to propagation of a wavefield is intended to refer to the virtual wavefield in accounting for the function of the WTD.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A method of retrieving a phase of a wavefield comprising the steps of:
providing an estimate of the wavefield φ₀ at an initial plane; and
propagating the wavefield to and fro between an entrance plane (125, 225) being a plane having an area to which the wavefield is confined and a detector plane (140, 240 340) via a wavefield transform device (130, 230, 330, 630), wherein at the entrance plane a support constraint is applied (410) and at the detector plane a magnitude constraint (450) is applied, the wavefield transform device being arranged to apply a wavefield transform function (430, 470) to the wavefield, wherein the wavefield transform function is characterised by a finite deviation from a lens function.

2. A method as claimed in claim 1 wherein the wavefield transform function is applied (430) to the wavefield as the wavefield passes between the entrance plane and the detector plane in a first direction and an inverse of the wavefield transform function being applied (470) by the device to the wavefield as it passes between the entrance plane and the detector plane in a second direction opposite the first direction.

3. A method as claimed in claim 1 or claim 2 comprising the step of iteratively calculating phase of the wavefield by repeatedly propagating the wavefield to and fro between the entrance plane and the detector plane.

4. A method as claimed in any preceding claim wherein the wavefield transform function is characterized by application of a Fourier transform to the wavefield, subsequently multiplying the wavefield by a modulation function, subsequently applying a further Fourier transform to the wavefield, the modulation function being a function having a finite deviation from a lens function

5. A method as claimed in any preceding claim wherein the support constraint S is applied according to the equation:
φₙ₊₁=φ′ₙS+β(φ′ₙ−φₙ)(1−S), (3)
where φₙ and φ′ₙ are a current and an updated estimate of an entrance wavefield of an n^{th} iteration respectively, φ′ₙ being set equal to φₙ at a first iteration.

6. A method as claimed in claim 5 wherein S takes a value of unity at pixels where the wavefield to be measured is assumed to have significant value, and zero otherwise.

7. A method as claimed in any preceding claim whereby the magnitude constraint is applied to determine an estimate of the wavefield at the detector plane φₙ₊₁^{D} according to the equation φₙ₊₁^{D}=Aₙ₊₁ exp(iφₙ₊₁), where Aₙ₊₁ and φₙ₊₁ denote amplitude and phase, respectively, of the wavefield at the detector.

8. A method as claimed in claim 7 wherein the magnitude constraint is applied according to the equation φ′ₙ₊₁^{D}=P(I)exp(iφₙ₊₁), where φ′ₙ₊₁^{D} is the wavefield at the detector after applying the magnitude constraint, I is the recorded diffraction intensity and P(I) is a function of intensity I.

9. A method as claimed in claim 8 wherein P(I) takes the form P(I)=I^{γ} where γ is a constant.

10. A method as claimed in claim 9 comprising the step of setting γ to a value substantially in the range of from around 0.5 to 2.

11. A method as claimed in claim 9 or claim 10 comprising the steps of performing n₁ iterations with a first value of γ, subsequently performing n₂ iterations with a second value of γ.

12. A method as claimed in claim 11 wherein the first value of γ is greater than the second value.

13. A method as claimed in claim 11 or claim 12 wherein the second value of γ is 0.5.

14. A method as claimed in claim 5 or any one of claims 6 to 13 depending through claim 6 comprising the step of selecting β to have a value in the range of from around 0.4 to around 0.8.

15. A method as claimed in claim 14 comprising the step of selecting β to have a value of 0.62.

16. A method as claimed in claim 9 as depending through claim 5 or any one of claims 10 to 15 depending through claim 9 as depending through claim 5 comprising selecting values of γ, β and S to enable a signal to error ratio SER to have a value of less than or substantially equal to 10⁻⁵ after around 100 iterations.

17. A method as claimed in any preceding claim preceded by the step of providing an initial estimate of the wavefield at an initial plane.

18. A method as claimed in claim 17 wherein the initial plane provided at a location which is one selected from amongst coincident with the entrance plane, coincident with the detector plane and between the entrance plane and the detector plane.

19. A method as claimed in any preceding claim wherein the wavefield transform device is arranged to exhibit one selected from amongst a linear response and a nonlinear response to an incident wavefield.

20. A method as claimed in any preceding claim wherein the wavefield transform device is arranged to have a complex transmission being a transmission exhibiting both loss and phase retardance.

21. A method as claimed in any preceding claim wherein the wavefield transform device comprises at least one selected from amongst a phase plate, a one dimensional grating, a two dimensional grating, a slab of crystal and a spatial light modulator.

22. A method as claimed in any preceding claim wherein the wavefield transform device comprises a plurality of cross-coupled optical fibres arranged to convey light incident from an inlet plane of the wavefield transform device to an exit plane of the wavefield transform device.

23. A method as claimed in claim 22 wherein the device is arranged to convey light between respective positions of the inlet and exit planes of the device such that the wavefield transform function is characterised by a finite deviation from a lens function by virtue of at least one selected from amongst a correspondence between respective positions of ends of respective fibres at the inlet and exit planes of the device and a length of respective fibres.

24. A method as claimed in any preceding claim wherein the wavefield transform device is arranged to be one selected from amongst transmissive of incident radiation and reflective of incident radiation.

25. A method as claimed in any preceding claim wherein the wavefield transform device comprises a plurality of pixel elements.

26. A method as claimed in any preceding claim comprising the step of adjusting an orientation of the wavefield transform device with respect to the detector and/or the entrance plane.

27. A method as claimed in any preceding claim comprising the step of providing a plurality of waveform transform devices.

28. A method as claimed in any preceding claim comprising the step of providing a plurality of waveform transform devices in a cascade configuration whereby a wavefield is arranged to pass between the entrance and detector planes via each of the plurality of devices.

29. A method as claimed in any preceding claim wherein the wavefield transform function is one selected from amongst discrete and continuous.

30. A method as claimed in any preceding claim comprising the step of providing a waveform transform device comprising at least one selected from amongst an aberrated lens and a complex lens system having non-negligible aberration.

31. A method as claimed in any preceding claim wherein the waveform transform function is one selected from amongst a reversible operator and a non-multiplicative operator.

32. A method as claimed in any preceding claim wherein the data recorded by the detector is arranged to correspond to one selected from amongst a Fraunhofer diffraction pattern, a Fresnel diffraction pattern and an aberrated image.

33. A method as claimed in any preceding claim wherein the support constraint is one selected from amongst a length of a 1D region, a boundary of a 2D area and a 3D volume.

34. A method as claimed in any preceding claim wherein the support constraint is applied to a plurality of spatially separated regions.

35. A method as claimed in any preceding claim wherein the wavefield is one selected from amongst a 3D wavefield, a 2D wavefield and a 1D signal.

36. A method as claimed in any preceding claim wherein the wavefield transform device is arranged to scatter at least one selected from amongst electromagnetic radiation, optical photons, x-ray photons, electrons, neutrons and protons.

37. A method as claimed in any preceding claim wherein the wavefield comprises electromagnetic radiation selected from amongst terahertz frequency radiation, infrared radiation, visible light radiation, deep-ultraviolet radiation, soft X-ray radiation and hard X-ray radiation.

38. A method as claimed in any preceding claim wherein the wavefield is arranged to comprise substantially coherent radiation.

39. A method as claimed in any preceding claim wherein the wavefield is arranged to consist substantially of coherent radiation.

40. A method as claimed in any preceding claim wherein the wavefield is a wavefield scattered by an object.

41. A method as claimed in claim 40 comprising the step of calculating phase of the wavefield in one or more planes of the object.

42. A method as claimed in any preceding claim comprising calculating phase and amplitude of the wavefield at a required location of a path of the wavefield.

43. A method of retrieving a phase of a wavefield comprising the steps of:
providing a wavefield transform device (130, 230, 330, 630) arranged to apply a wavefield transform function (430, 470) to a wavefield, wherein the wavefield transform function is characterized by a function having a finite deviation from a lens function;
passing a wavefield from an entrance plane (125, 225) to a detector plane (140, 240, 340) via the wavefield transform device and recording an intensity of the wavefield at the detector plane by means of a detector (340),
the method further comprising the steps of:
propagating the wavefield in a virtual manner to and fro between the entrance plane and the detector plane via the wavefield transform device, wherein at the entrance plane a support constraint is applied (410) and at the detector plane a magnitude constraint is applied (450), the magnitude constraint corresponding to the intensity recorded by the detector.

44. A method as claimed in claim 43 wherein the wavefield incident on the wavefield transform device is a wavefield that has been scattered by an object (120, 220, 320).

45. A method as claimed in any one of claim 43 or 44 wherein the step of propagating the wavefield in a virtual manner to and fro between the entrance plane and the detector plane is preceded by the step of providing an estimate of the wavefield φ₀ at an initial plane.

46. Apparatus for retrieving a phase of a wavefield comprising:
a wavefield transform device (130, 230, 330, 630) arranged to apply a wavefield transform function (430, 470) to a wavefield, wherein the wavefield transform function is characterized by a function having a finite deviation from a lens function;
a detector (140, 240, 340) responsive to intensity of the wavefield; and
a computer system,
the apparatus being arranged to allow a wavefield to propagate from the entrance plane (125, 225), being a plane in which the wavefield is confined to a finite area, via the wavefield transform device to the detector,
the computer system being arranged to propagate a virtual wavefield to and fro between the entrance plane and the detector,
the computer system being arranged to apply a support constraint (410) to the wavefield at the entrance plane and a magnitude constraint (450) to the wavefield at the detector, the system being arranged to apply the wavefield transform function to the wavefield as the wavefield is propagated between the entrance plane and the detector, thereby to retrieve the phase of the wavefield at a required position of the wavefield.

47. Apparatus as claimed in claim 46 wherein the computer system is arranged iteratively to calculate phase of the wavefield by repeatedly propagating the wavefield to and fro between the entrance plane and the detector plane.

48. Apparatus as claimed in claim 46 or 47 wherein the system is arranged to apply the wavefield transform function to the wavefield as the wavefield passes between the entrance plane and the detector in a first direction and an inverse of the wavefield transform function as the wavefield passes between the entrance plane and the detector in a second direction opposite the first direction.

49. Apparatus as claimed in any one of claims 46 to 48 wherein the step of propagating a virtual wavefield to and fro between the entrance plane and the detector is preceded by the step of propagating the wavefield from an initial plane.

50. Apparatus as claimed in claim 49 wherein the computer system is arranged to provide an estimate of the wavefield at the initial plane and subsequently to propagate the wavefield from the initial plane and between the entrance plane and the detector.

51. Apparatus as claimed in any one of claim 49 or 50 wherein the computer system is arranged to prompt a user to input an estimate of the wavefield at the initial plane and subsequently to propagate the wavefield from the initial plane and between the entrance plane and the detector.

52. A computer program comprising program instructions for causing a computer to perform the method as claimed in any one of claims 1 to 45.

53. A computer program product having thereon computer program code means, when said program is loaded, to cause the computer to retrieve phase of a wavefield in accordance with a method as claimed in any one of claims 1 to 45.
